(19) United States
(12) Patent Application Publication
(10) Pub. No.: US 2026/0365825 A1
(43) Pub. Date: Nov. 19, 2026

(54) Compositions and Methods of Making Polymer-Encapsulated Pigment Dispersions

(71) Applicant: Cabot Corporation, Boston, MA (US)

(72) Inventors: Yuanxin Chen, Westford, MA (US); Heather E. Clarke, Nashua, NH (US)

(21) Appl. No.: 19/674,309

(22) Filed: May 12, 2026

Related U.S. Application Data
(60) Provisional application No. 63/804,997, filed on May 13, 2025.

(51) Int. Cl. C08K 5/42; C08J 3/24; C08K 11/00

(52) U.S. Cl. CPC C08K 5/42; C08J 3/24; C08K 11/00

(57) ABSTRACT

Disclosed herein are methods and compositions comprising polymer-encapsulated pigment dispersions. The method comprises combining a polymer-pigment predispersion with at least one organic biological buffering agent prior to a crosslinking step, wherein the buffering agent has a pKa ranging from 6 to 8 and the polymer of the polymer-pigment predispersion comprises first monomers selected from ethylenically unsaturated hydrophobic monomers, and second monomers selected from maleic anhydride, maleic acid, acrylic acid, methacrylic acid, benzylacrylic acid, benzylmethacrylic acid, and salts, esters, imides, and amides thereof. Also disclosed herein are compositions comprising the resulting polymer-encapsulated pigment dispersions.

### FIELD OF THE INVENTION

Disclosed herein are compositions and methods of making polymer-encapsulated pigment dispersions, including crosslinking reactions with at least one organic buffering agent.

### BACKGROUND

For pigment-based inks in inkjet printing applications, there is a continual need to maintain the stability of such pigment-based dispersions in aqueous media. Generally, the pigments are provided with ionic or ionizable groups to enable a dispersed state. One method involves attaching a variety of different functional groups directly to the surface of the pigment to form a self-dispersed pigments in which the functional groups are ionic or ionizable and are capable of interacting with aqueous media. Another method involves the use of polymer dispersants having ionic or ionizable groups. The polymer dispersant can be provided as separate polymer particles or can encapsulate a pigment via crosslinking reactions. There is a continual need for manufacturing pigments for inkjet ink applications in a sustainable manner.

### SUMMARY

One aspect is a method of making a polymer-encapsulated pigment dispersion comprises combining a polymer-pigment predispersion with at least one organic biological buffering agent prior to a crosslinking step. The buffering agent has a pKa ranging from 6 to 8. The buffering agent can be free of at least one of NH₂, OH, and CO₂H groups, e.g., free of NH₂ groups, or free of OH groups, or free of CO₂H groups, or free of NH₂ and OH groups, or free of NH₂, OH, and CO₂H groups. Additionally, or in the alternative, the buffering agent comprises a piperazinyl or morpholinyl residue. The polymer of the polymer-pigment predispersion (or the resulting crosslinked polymer) comprises first monomers selected from ethylenically unsaturated hydrophobic monomers, and second monomers selected from maleic anhydride, maleic acid, acrylic acid, methacrylic acid, benzylacrylic acid, benzylmethacrylic acid, and salts, esters, imides, and amides thereof. The method further comprises combining the polymer-pigment predispersion and buffering agent mixture with a crosslinking agent to form the polymer-encapsulated pigment comprising a crosslinked polymer that is crosslinked through carboxylate groups of the second monomers.

Another aspect is a composition comprising:
at least one pigment;
a liquid vehicle;
at least one polymer encapsulating the at least one pigment, the at least one polymer comprising first monomers selected from ethylenically unsaturated hydrophobic monomers, and second monomers selected from maleic anhydride, maleic acid, acrylic acid, methacrylic acid, benzylacrylic acid, benzylmethacrylic acid, and salts, esters, imides, and amides thereof, wherein the at least one polymer is crosslinked through at least 10% of carboxylate groups of the second monomer; and
at least one organic biological buffering agent having a pKa ranging from 6 to 8, wherein the at least one organic biological buffering agent is present in an amount ranging from 10 ppb to 1% by weight relative to the total weight of the composition.

### DETAILED DESCRIPTION

Disclosed herein are compositions and methods relating to polymer encapsulated pigment dispersions that can be manufactured in a more environmentally compatible manner.

Certain polymer-encapsulated pigment dispersions are prepared by initially combining a polymer with a pigment followed by a crosslinking reaction. The polymer has ionic or ionizable groups in its backbone that are at least partially in ionic form (e.g., partially or fully anionic) to provide sufficient charge to stabilize the pigment particles in water. Once the pigment and polymer are combined in water, they are predispersed to sufficiently wet the pigment surface, resulting in a polymer-pigment predispersion that helps ensures that the polymer is in substantially close proximity to the pigment during the crosslinking reaction.

The crosslinking reaction occurs through respective functional groups of the polymer and crosslinking agent. As an option, the functional groups on the polymer can be the same as the functional groups for dispersing, e.g., ionizable groups. For example, where the crosslinking agent has an epoxide functional group, the polymer can have carboxylic acid groups to form a polymer that is crosslinked via ester linkages.

Without wishing to be bound by any of theory, when the crosslinking reaction occurs in liquid medium that comprises water (e.g., an aqueous environment) and prior to the crosslinking reaction, the optimal pH of the polymer-pigment predispersion ranges from 6 to 9. Without wishing to be bound by any of theory, maintaining the pH of the polymer-pigment predispersion at 6 to 9, or other levels disclosed herein, can provide at least one of: (a) sufficient protonation of the polymer to enable reaction with a functional group of a crosslinking agent, e.g., an epoxide group, (b) counteracting pH increases from the generation of hydroxyl groups, if any (e.g., from reaction between carboxylic acids and epoxide groups), and (c) decreasing other side reactions that occur at high pH; for example, at higher pH levels, increased hydrolysis of the crosslinker may occur, resulting in reduced crosslinking efficiency.

Approaches for pH control typically involve the use of a strong base or other systems that may raise toxicity and/or environmental issues, such as discharge of raw materials and/or by-products into the waste stream. As such, there is a continuing need for alternative approaches to pH control that are more sustainable and can provide benefits when the ink is used in applications that require regulatory compliance.

Accordingly, disclosed herein is a method of making a polymer encapsulated pigment dispersion combining a polymer-pigment predispersion with at least one organic biological buffering agent prior to a crosslinking step. It has been discovered that the use of an organic biological buffering agent provides a sustainable alternative that can help alleviate toxicity and/or environmental concerns. Moreover, it has also been discovered that the crosslinking reaction with the organic biological buffering agent achieves good crosslinking and product performance.

Organic biological buffering agents are known in biological and biochemical applications and have been regarded as safe and effective with good chemical stability. The use of such agents were not often used for inkjet ink applications and unknown for use in crosslinking reactions in the preparation of polymer-encapsulated pigment dispersions. However, it was a surprising discovery that the use of biological buffering agents in pigment dispersions, e.g., for pH control of crosslinking reactions for the preparation of polymer-encapsulated pigment dispersions, resulted in good reactivity and end product performance, in addition to being a sustainable alternative. Moreover, the high water solubility of organic buffering agents are well-suited for applications involving aqueous pigment dispersions. Other properties of organic buffering agents that make them useful for aqueous inkjet pigment dispersions include low metal binding capability and biological inertness.

Prior to combining the polymer-pigment predispersion with the at least one biological buffering agent, the pH of the polymer-pigment predispersion can range from 6 to 10. As an option, combining the at least one organic buffering agent with the polymer pre-dispersion results in a pH ranging from 6 to 9 e.g., from 6 to 8.5, from 6 to 8, from 6.5 to 9, from 6.5 to 8.5, or from 6.5 to 8, from 7 to 9, from 7 to 8.5, from 7 to 8, from 7.2 to 9, from 7.2 to 8.5, from 7.2 to 8, from 7.3 to 9, from 7.3 to 8.5, from 7.3 to 8, from 7.4 to 9, from 7.4 to 8.5, from 7.4 to 8, from 7.5 to 9, from 7.5 to 8.5, or from 7.5 to 8.

As an option, the at least one biological buffering agent has a pKa ranging from 6 to 8, e.g., from 6 to 7.8, from 6 to 7.5, from 6 to 7.4, from 6 to 7.3, from 6 to 7.2, from 6.5 to 8, from 6.5 to 7.8, from 6.5 to 7.5, from 6.5 to 7.4, from 6.5 to 7.3, from 6.7 to 7.2, from 6.7 to 8, from 6.7 to 7.8, from 6.7 to 7.5, from 6.7 to 7.4, from 6.7 to 7.3, or from 6.7 to 7.2.

As an option the at least one organic buffering agent is selected from Good's buffers. Good's buffers are a set of 20 zwitterionic compounds having pKa values ranging from 6 to 8.5 and have many of the properties desired for aqueous pigment dispersions disclosed herein, including high water solubility, low metal binding capability, and biological inertness.

As an option, the at least one buffering agent is free of at least one of NH₂, OH, and CO₂H groups, e.g., free of NH₂ groups, or free of OH groups, or free of CO₂H groups, or free of NH₂ and OH groups, or free of NH₂, OH, and CO₂H groups. As an option, the at least one buffering agent is free of NH₂ and OH groups. For example, a crosslinking agent having epoxide groups can be reactive with NH₂ and OH functional groups, which can potentially result in undesirable side reactions that can affect the crosslinking efficiency (e.g., yield). As an option, the at least one buffering agent is free of CO₂H groups. As an option, the at least one buffering agent is further free of CO₂H groups, i.e., free of NH₂, and CO₂H groups, or free of OH, and CO₂H groups, or free of NH₂, OH, and CO₂H groups.

As an option, the at least one buffering agent has an acid group selected from sulfonic acids and salts thereof, e.g., C₁-C₆ sulfonic acids.

As an option, the organic buffering agent has a basic group selected from secondary or tertiary amines, or —O— groups, where O is part of an ether linkage. As an option, the basic group can be a heterocyclic ring containing the —O— group and/or a secondary amine, e.g., morpholine or piperazine rings. As an option, the at least one buffering agent comprises a piperazinyl or morpholinyl residue. As another option, the at least one buffering agent has an acid group selected from sulfonic acids and salts thereof and a basic group selected from morpholine or piperazine rings (i.e., comprises a piperazinyl or morpholinyl residue). As another option, the sulfonic acid group (and/or salts thereof) is bonded to the piperazinyl or morpholinyl residue, e.g., bonded to the piperazinyl nitrogen or morpholinyl nitrogen.

As an option, the method of making a polymer-encapsulated pigment, comprises:
combining a polymer-pigment predispersion with at least one organic biological buffering agent to form a mixture, wherein the buffering agent has a pKa ranging from 6 to 8 and is free of NH₂ and OH groups, and wherein the polymer of the polymer-pigment predispersion comprises first monomers selected from ethylenically unsaturated hydrophobic monomers, and second monomers selected from maleic anhydride, maleic acid, acrylic acid, methacrylic acid, benzylacrylic acid, benzylmethacrylic acid, and salts, esters, imides, and amides thereof, and
combining the polymer-pigment predispersion and buffering agent mixture with a crosslinking agent to form the polymer-encapsulated pigment comprising a crosslinked polymer that is crosslinked through carboxylate groups of the second monomers.

As another option the method of making a polymer-encapsulated pigment, comprises:
combining a polymer-pigment predispersion with at least one organic biological buffering agent to form a mixture, wherein the buffering agent has a pKa ranging from 6 to 8 and comprises a piperazinyl or morpholinyl residue, and wherein the polymer of the polymer-pigment predispersion comprises first monomers selected from ethylenically unsaturated hydrophobic monomers, and second monomers selected from maleic anhydride, maleic acid, acrylic acid, methacrylic acid, benzylacrylic acid, benzylmethacrylic acid, and salts, esters, imides, and amides thereof, and
combining the polymer-pigment predispersion and buffering agent mixture with a crosslinking agent to form the polymer-encapsulated pigment comprising a crosslinked polymer that is crosslinked through carboxylate groups of the second monomers.

As an option, the at least one buffering agent is selected from 3-(N-morpholino) propanesulfonic acid (MOPS), 2-(N-morpholino) ethanesulfonic acid (MES), 1,4-Piperazinediethanesulfonic acid (PIPES), 4-(2-Hydroxyethyl)-1-piperazineethanesulfonic acid (HEPES), and salts thereof. As an option, the at least one buffering agent is selected from 3-(N-morpholino) propanesulfonic acid (MOPS), 2-(N-morpholino) ethanesulfonic acid (MES), and 1,4-Piperazinediethanesulfonic acid (PIPES), or from 3-(N-morpholino) propanesulfonic acid (MOPS), 1,4-Piperazinediethanesulfonic acid (PIPES), 4-(2-Hydroxyethyl)-1-piperazineethanesulfonic acid (HEPES), or from 3-(N-morpholino) propanesulfonic acid (MOPS), 2-(N-morpholino) ethanesulfonic acid (MES), 4-(2-Hydroxyethyl)-1-piperazineethanesulfonic acid (HEPES), and salts thereof. As an option, the at least one buffering agent is selected from MOPS and any one of MES, PIPES, and HEPES, or from MES and PIPES or HEPES, or from PIPES and HEPES, and salts thereof.

As disclosed herein, a polymer-pigment predispersion is prepared prior to the crosslinking reaction. As an option, the preparation of the predispersion allows sufficient wetting of the pigment surface to stabilize the particles and can optionally reduce particle size to a desired target. As an option, the polymer-pigment predispersion can be prepared by subjecting the polymer and pigment to high shear conditions in the presence of a liquid medium, such as an aqueous liquid medium. Such high shear conditions can be accomplished with equipment capable of providing a grinding, impact, or similar impingement action, such as horizontal media mills, vertical media mills such as attritors, ball mill, hammer mills, pin disk mills, fluid energy mills, jet mills, fluid jet mills, impingement jet mills, rotostators, pelletizers, homogenizers, sonicators, cavitators, and the like. As an option, “high shear” as used herein refers to an energy sufficient to reduce the particle size distribution of the polymer-pigment dispersion to a target size. Accordingly, the polymer-pigment predispersion may be subjected to conventional size reduction or comminution techniques, such as ball or jet milling or sonication, to achieve a desired particle size.

As an option, the high shear conditions can include an initial stirring or shearing step (which can be performed under low or high shear conditions) followed by high shear conditions as disclosed herein. For example, the predispersion can be prepared by high shear mixing or stirring, followed by known milling methods (e.g., ball or jet mill). Particle size control can be further achieved with filtration, centrifugation, etc.

The polymer of the polymer-pigment predispersion can be (or the crosslinked polymer can comprise) a copolymer (e.g., a random copolymer) comprising first monomers selected from ethylenically unsaturated hydrophobic monomers, and second monomers selected from maleic anhydride, maleic acid, acrylic acid, methacrylic acid, benzylacrylic acid, benzylmethacrylic acid, and salts, esters, imides, and amides thereof. The second monomers contain ionic or ionizable (hydrolyzable) groups that can react with a crosslinking agent, e.g., anyhydrides, carboxylic acids, and salts, esters, imides, and amides thereof.

The first monomers can be selected from ethylenically unsaturated hydrophobic monomers. An “ethylenically unsaturated” monomer as used herein contains a polymerizable C═C group. Exemplary ethylenically unsaturated hydrophobic monomers include acrylate and methacrylate acid groups, vinyl groups, and allyl groups. As an option, the ethylenically unsaturated hydrophobic monomers have the formula CH₂═CR¹R², wherein R¹ and R² are independently selected from H, C₁-C₂₀ alkyl (e.g., C₁-C₁₂ or C₁-C₆ alkyl), C₅-C₂₀ aryl (e.g., C₅-C₁₂ aryl, C₆-C₁₂ aryl, C₅-C₁₀ aryl, C₆-C₁₀ aryl), C₆-C₂₀ aralkyl (aryl-substituted alkyl, e.g., C₆-C₁₂ aralkyl, C₆-C₁₀ aralkyl), and C₆-C₂₀ alkaryl (alkyl-substituted aryl, e.g., C₆-C₁₂ alkaryl, C₆-C₁₀ alkaryl). R¹ and R² can be linear or branched. As another option, the carbon atoms of R¹ and R² can be optionally substituted with at least one heteroatom selected from O, N, and S. In one embodiment, R¹ and R² are independently selected from H, C₁-C₁₂ alkyl, C₅-C₂₀ aryl, C₆-C₂₀ aralkyl, and C₆-C₂₀ alkaryl. In another embodiment, R¹ and R² are independently selected from H, C₁-C₁₂ alkyl, C₆-C₁₂ aryl, C₆-C₁₂ aralkyl, and C₆-C₁₂ alkaryl. As yet another option, R¹ and R² are independently selected from H, C₁-C₁₂ alkyl, and C₅-C₁₂ aryl (e.g., C₅-C₁₀ aryl) or H, C₁-C₁₂ alkyl, and C₆-C₁₂ aryl (e.g., C₆-C₁₀ aryl). As yet another option, R¹ and R² are independently selected from H and C₅-C₁₂ aryl (e.g., C₅-C₁₀ aryl) or H and C₆-C₁₂ aryl (e.g., C₆-C₁₀ aryl).

As an option, the ethylenically unsaturated hydrophobic monomers are selected from those containing vinyl groups, e.g., α-olefins. Exemplary monomers containing vinyl groups include ethylene, propylene, 1-butene, 1-pentene, 1-hexene, 1-heptene, 1-octene, 1-nonene, 1-decene, 1-dodecene, 1-tetradecene, 1-hexadecene, 1-heptadecene, 1-octadecene, 2-methyl-1-butene, 3,3-dimethyl-1-pentene, 2-methyl-1-heptene, 4,4-dimethyl-1-heptene, 3,3-dimethyl-1-hexene, 4-methyl-1-pentene, isobutylene, di-isobutylene, styrene, α-methyl styrene, and vinyl toluene and mixtures thereof.

As another option, the ethylenically unsaturated hydrophobic monomers are selected from ethylenically unsaturated esters, e.g., ethylenically unsaturated esters of an aliphatic acid wherein the acid moiety has 3-8 carbon atoms, e.g., 3-6 carbon atoms, and the ester moiety has 1-8, e.g., 1-6 or 1-4 carbon atoms. Exemplary ethylenically unsaturated esters include vinyl acetate, allyl acetate, methyl methacrylate, ethyl acrylate, n-butyl acrylate, n-butyl methacrylate, n-octyl acrylate, benzyl acrylate, acrylonitrile, and, acrylamide.

As an option, the ethylenically unsaturated hydrophobic monomers are selected from styrene, α-methyl styrene, ethylene, propylene, 1-butylene, isobutylene, butadiene, and methyl vinyl ether. As an option, the ethylenically unsaturated hydrophobic monomers are selected from styrene and α-methyl styrene. As another option, the ethylenically unsaturated hydrophobic monomers comprise styrene.

As an option, the first monomers can comprise two or more different ethylenically unsaturated hydrophobic monomers.

The second monomers can be selected from maleic anhydride, maleic acid, acrylic acid, methacrylic acid, benzylacrylic acid, benzylmethacrylic acid, and salts, esters, imides, and amides thereof. For example, the second monomers can comprise maleic anhydride or maleic acid or a mixture of maleic anhydride and maleic acid (and/or salts, esters, imides, and amides thereof). As another example, the second monomers can comprise acrylic acid and/or methacrylic acid and/or benzylacrylic acid and/or benzylmethacrylic acid, and salts, esters, imides, and amides thereof, or a mixture of two or more of acrylic acid, methacrylic acid, benzylacrylic acid, benzylmethacrylic acid, and salts, esters, imides, and amides thereof. As an option, the second monomers comprise maleic anhydride or maleic acid or a mixture of maleic anhydride or maleic acid and salts thereof. As another option, the second monomers comprise at least one of (or at least two of) acrylic acid and/or methacrylic acid and/or benzylacrylic acid and/or benzylmethacrylic acid, and salts thereof. As another option, the second monomers can comprise acrylic acid and/or methacrylic acid and salts, esters, imides, and amides thereof.

Any combination of the disclosed first and second monomers can be used in the polymer of the polymer-pigment predispersion (or the resulting crosslinked polymer). As an option, the first monomers are selected from styrene and α-methyl styrene, and the second monomers are selected from maleic anhydride, maleic acid, and salts thereof. As another option, the first monomers are selected from styrene and α-methyl styrene, and the second monomers are selected from acrylic acid, methacrylic acid, and salts thereof. As yet another option, the first monomers are selected from styrene and α-methyl styrene, and the second monomers are selected from benzylacrylic acid, benzylmethacrylic acid, and salts, thereof.

As an option, the polymer of the polymer-pigment predispersion (or the resulting crosslinked polymer) comprises alpha olefin maleic anhydride copolymers, e.g., may be prepared by any of a number of conventional polymerization processes including those as set forth in U.S. Reissue Pat. No. Re. 28,475 and U.S. Pat. Nos. 3,553,117, 3,560,455, 3,560, 456, 3,560,457, 3,488,311, 4,522, 992, 4,358,573, 4,871,823, 4,859,752, and 5, 336,727, the disclosures of which are incorporated herein by reference. The at least one polymer can be prepared, for example, in neat alkenes at 160 °C; in solvents such as the aromatic hydrocarbons that dissolve the monomers but precipitate the polymers (precipitation polymerization or suspension polymerization); or in solvents such as the ketones that dissolve both the reactants and the polymers (solution polymerization). In one embodiment, temperature for solution polymerization ranges from 60-80 °C. The radical initiators are usually AIBN or benzoyl peroxide.

As an option, the first monomers comprise styrene and the second monomers comprise at least one monomer selected from maleic anhydride, maleic acid, combinations thereof, and salts thereof. In one embodiment, the at least one polymer is selected from styrene-maleic anhydride (SMA) polymers. In one embodiment, some or all of the maleic anhydride monomers are hydrolyzed to maleic acid, resulting in a polymer comprising styrene, maleic anhydride, and maleic acid (and salts thereof) monomers. Additional monomers, such as acrylate and methacrylates, may also be present. In one embodiment, the additional monomers are present in low levels. For example, the styrene-maleic anhydride polymers can be a polymer of styrene, maleic anhydride, and an additional monomer having a mole ratio of polymerized styrene and maleic anhydride to other polymerized monomer that is greater than 1/1, such as greater than 5/1, greater than 10/1, and greater than 20/1. Such polymers can be prepared using any method known in the art, including polymerization using a continuous monomer feed as well as using a one-pot polymerization process. In one embodiment, the styrene-maleic anhydride polymer is prepared with a continuous monomer feed method. Examples of such polymer-encapsulated pigment dispersions are disclosed in U.S. Pat. No. 10,233,342, the disclosure of which is incorporated by reference herein.

As an option, the first monomers comprise styrene and/or α-methylstyrene and the second monomers comprise acrylic and/or methacrylic resins. Examples of styrene-acrylic or styrene-methacrylic resins such as styrene-(meth)acrylic acid copolymers, styrene-(meth)acrylic acid-(meth)acrylate ester copolymers, styrene-α-methylstyrene-(meth)acrylic acid copolymers, styrene-α-methylstyrene-(meth)acrylic acid-(meth)acrylate ester copolymers; vinyl naphthalene-acrylic or methacrylic acid copolymers; and. Styrene acrylic copolymers are available commercially as JONCRYL® acrylic resins available from BASF (e.g., 683, HPD296, HPD671, ECO675, HPD496-A). As an option, the first monomers are styrene and the second monomers are acrylics, i.e., styrene acrylics. Styrene acrylics can include acrylic monomers (acrylic acid, acrylate) that are unsubstituted or substituted with an additional side chain, such as C₁-C₁₂ branched or straight chain alkyls in which the carbon backbone can be optionally substituted with one or more oxygen atom (e.g., 1-3 oxygen atoms). Such styrene acrylics can include acrylate monomers such as butyl acrylate, octyl acrylate, 2-ethylhexyl acrylate, and carbitol acrylate.

As an option, the second monomers are present in the at least one polymer in an amount ranging from 10 to 60 mol % relative to the at least one polymer, e.g., an amount ranging from 10 to 50 mol %, from 10 to 40 mol %, from 10 to 35 mol %, from 20 to 60 mol %, from 20 to 50 mol %, from 20 to 40 mol %, from 20% to 35 mol % relative to the at least one polymer. In one embodiment, the at least one polymer comprises the first monomers in an amount ranging from 40 to 90 mol %, from 50 to 90 mol %, 40 to 80 mol %, or from 50 to 80 mol %. In another embodiment, the at least one polymer comprises the first monomers in an amount ranging from 67 to 80 mol % and second monomers in an amount ranging from 20 to 33 mol % relative to the at least one polymer. The at least one polymer can be a random copolymer or alternating copolymer.

The polymer of the polymer-pigment predispersion can be crosslinked through the second monomers, i.e., through reaction between the carboxylate groups and at least one crosslinking agent. As an option, the at least one polymer is crosslinked via ester linkages. For example, crosslinking agents such as multifunctional reagents (e.g., difunctional, trifunctional, etc.) containing two or more epoxy groups thereof can be used to form ester linkages, e.g., in reaction with carboxylate-containing groups of the second monomers. In one embodiment, the second monomers (e.g., comprising maleic anhydride, maleic acid, and salts, esters, imides, and amides thereof, etc.) of at least two different polymers can react with the crosslinking agents. In one embodiment, the cross-linking agents are selected from epoxy-containing compounds, e.g., di- or tri-epoxy-based compounds, such as trimethylolpropane polyglycidyl ether, e.g., to form cross-linked polymers comprising ester linkages. In one embodiment, the ester linkage is derived from a reaction between an epoxy-containing compounds (e.g., di- and tri-glycidyl ether compounds such as trimethylolpropane polyglycidyl ether) and carboxylate-containing groups of the second monomers.

The at least one polymer is crosslinked through carboxylate-containing groups of the second monomer, e.g., anhydrides, carboxylic acids and salts, esters, imides, and amides thereof, or carboxylic acids and salts thereof. In one embodiment, the at least one polymer, if containing anhydrides, carboxylic acids and salts, esters, imides, and amides thereof, can be hydrolyzed to generate carboxylate-containing groups (e.g., carboxylic acid or carboxylate), which can be reacted with the crosslinking agent. Hydrolysis can be performed to generate the carboxylic acid or carboxylate either prior to concurrent with addition of the crosslinking agent. As an option, hydrolysis is performed prior to addition of the crosslinking agent.

As an option, the at least one polymer is crosslinked through at least 10% of the carboxylate-containing groups of the second monomer, e.g., 10% to 50%, 10% to 40%, or 10% to 30% of the carboxylate-containing groups of the second monomer. In one embodiment, the number of carboxylate-containing groups targeted for crosslinking (“% CO₂ targeted”) can be determined by the amount of crosslinking agent added.

As an option, it is generally desired to have a crosslinked polymer with ionic or ionizable groups to maintain a stable dispersion in an aqueous medium, whether as a polymer-encapsulated pigment dispersion or an ink containing the pigment dispersion. The ionic or ionizable groups can take the form of a carboxylic acid or carboxylate group or salts, esters, imides, and amides thereof, in which the number of such groups can be indicated by an acid number (mg KOH needed to neutralize the acidic groups in 1 g polymer). As an option, the acid number of the crosslinked polymer is defined as a theoretical value in relation to the acid number of the starting polymer (“AN (SP)”) and the percentage of carboxylate-containing targeted for crosslinking (“% CO₂ targeted”) according to the following equation:

AN(xlink)=AN(SP)−(% CO₂ targeted)×AN(SP)

As an option, the at least one (crosslinked) polymer has an acid number AN(xlink) of at least 100 mg KOH/g or at least 150, e.g., an acid number AN(xlink) ranging from 100 to 300, or from 150 to 300, or from 175 to 300 or from 200 to 300 mg KOH/g.

As an option, the crosslinked polymer has a weight average molecular weight (M_{w}) of at least 1000, e.g., at least 2000 or at least 3000. In another embodiment, the M_{w} is less than or equal to 80,000, or less than equal to 70,000. In one embodiment, the M_{w} ranges from 1,000 to 80,000, or from 1,000 to 70,000, or from 1,000 to 50,000, or from 1,000 to 25,000, or from 1,000 to 20,000, or from 1,000 to 15,000, or from 1,000 to 12,000, or from 2,000 to 80,000, or from 2,000 to 70,000, or from 2,000 to 50,000, or from 2,000 to 25,000, or from 2,000 to 20,000, or from 2,000 to 15,000, or from 2,000 to 12,000, or from 3,000 to 80,000, or from 3,000 to 70,000, or from 3,000 to 50,000, or from 3,000 to 25,000, or from 3,000 to 20,000, or from 3,000 to 15,000, or from 3,000 to 12,000, or from 5,000 to 80,000, or from 5,000 to 70,000, or from 5,000 to 50,000, or from 5,000 to 25,000, or from 5,000 to 20,000, or from 5,000 to 15,000, or from 5,000 to 12,000.

In some embodiments, the M_{w} of free polymer can approximate the M_{w} of the crosslinked polymer in the composition. As an option, the M_{w} of free polymer can approximate the M_{w} of the polymer encapsulating the pigment. As an option, the M_{w} of the crosslinked polymer can be determined by measuring the M_{w} of free polymer in the dispersion after crosslinking. M_{w} measurements can be performed by any method known in the art, e.g., such as gel permeation chromatography (GPC).

In some embodiments, it was a surprising discovery that the M_{w} of the crosslinked polymer increased by the use of organic biological buffering agent according to the methods disclosed herein compared to buffering agents previously used in the art. As an option, the crosslinked polymer has a weight average molecular weight (M_{w}) of at least 20,000, or at least 25,000, or at least 30,000, or at least 40,000, or at least 50,000. As an option, the crosslinked polymer has a weight average molecular weight (M_{w}) of up to 500,000 or even greater. As an option, the crosslinked polymer has a weight average molecular weight ranging from 20,000 to 500,000, e.g., from 25,000 to 500,000, from 30,000 to 500,000, from 40,000 to 500,000, from 50,000 to 500,000, from 20,000 to 400,000, from 25,000 to 400,000, from 30,000 to 400,000, from 40,000 to 400,000, from 50,000 to 400,000, from 20,000 to 300,000, from 25,000 to 300,000, from 30,000 to 300,000, from 40,000 to 300,000, from 50,000 to 300,000, from 20,000 to 200,000, from 25,000 to 200,000, from 30,000 to 200,000, from 40,000 to 200,000, or from 50,000 to 200,000. As an option, the second monomers are selected from maleic anhydride, maleic acid, and salts, esters, imides, and amides thereof. As another option, the second monomers are selected from acrylic acid, methacrylic acid, and salts, esters, imides, and amides thereof.

The pigment can be unmodified or modified. Pigments are solid materials generally in the form of a particulate or in a form readily formed into a particulate, such as a pressed cake. In one embodiment, the modified pigment has attached at least one moiety, e.g., acid groups (and partial salts, partial esters, salts, and esters thereof), and organic groups. In another embodiment, the modified pigment is an oxidized pigment. In another embodiment, the modified pigment further comprises attached moieties. In one embodiment, the modified pigment is self-dispersible such that an external dispersant is not required for dispersing the pigment (self-dispersed pigments).

The unmodified pigment can be any type of pigment conventionally used by those skilled in the art, such as black pigments and other colored pigments including blue, black, brown, cyan, green, white, violet, magenta, red, orange, or yellow pigments. Mixtures of different pigments can also be used. Representative examples of black pigments include various carbon blacks (Pigment Black 7) such as channel blacks, furnace blacks, gas blacks, and lamp blacks, and include, for example, carbon blacks sold as Regal®, Black Pearls®, Elftex®, Monarch®, Mogul®, and Vulcan® carbon blacks available from Cabot Corporation (such as Black Pearls® 2000, Black Pearls® 1400, Black Pearls® 1300, Black Pearls® 1100, Black Pearls® 1000, Black Pearls® 900, Black Pearls® 880, Black Pearls® 800, Black Pearls® 700, Black Pearls® 570, Black Pearls® L, Elftex® 8, Monarch® 1400, Monarch® 1300, Monarch® 1100, Monarch® 1000, Monarch® 900, Monarch® 880, Monarch® 800, Monarch® 700, Regal® 660, Mogul® L, Regal® 330, Regal® 400, Vulcan® P). Carbon blacks available from other suppliers can be used.

Suitable classes of colored pigments include, for example, anthraquinones, phthalocyanine blues, phthalocyanine greens, diazos, monoazos, pyranthrones, perylenes, heterocyclic yellows, quinacridones, quinolonoquinolones, and (thio) indigoids. Such pigments are commercially available in either powder or press cake form from a number of sources including, BASF Corporation, Engelhard Corporation, Sun Chemical Corporation, Clariant, and Dianippon Ink and Chemicals (DIC). Examples of other suitable colored pigments are described in the Colour Index, 3rd edition (The Society of Dyers and Colourists, 1982). In one embodiment, the pigment is a cyan pigment, such as Pigment Blue 15, Pigment Blue 15:3, Pigment Blue 15:4, or Pigment Blue 60, a magenta pigment, such as Pigment Red 122, Pigment Red 177, Pigment Red 185, Pigment Red 202, or Pigment Violet 19, a yellow pigment, such as Pigment Yellow 74, Pigment Yellow 128, Pigment Yellow 139, Pigment Yellow 155, Pigment Yellow 180, Pigment Yellow 185, Pigment Yellow 218, Pigment Yellow 220, or Pigment Yellow 221, an orange pigment, such as Pigment Orange 168, a green pigment, such as Pigment Green 7 or Pigment Green 36, or black pigment, such as carbon black.

In one embodiment, the self-dispersed pigment is an oxidized carbon black. In one embodiment, “oxidized carbon blacks” are carbon black pigments generally having a pH<7.0 that feature surface-bound ionic or ionizable groups such as one or more of alcohols (phenols, naphthols), lactones, carbonyls, carboxyls (e.g., carboxylic acids), anhydrides, ethers, and quinones. The extent of oxidation of carbon black can determine the surface concentration of these groups. In one embodiment, the oxidized carbon black is obtained by oxidizing an unmodified carbon black. Exemplary oxidizing agents for carbon blacks include oxygen gas, ozone, peroxides such as hydrogen peroxide, persulfates such as sodium and potassium persulfate, hypohalites such as sodium hypochlorite, nitric acid, and transition metal-containing oxidants such as permanganate salts, osmium tetroxide, chromium oxides, ceric ammonium nitrates, and mixtures thereof (e.g., mixtures of gaseous oxidants such as oxygen and ozone). In another embodiment, the oxidized carbon black is obtained from commercial sources, such as Black Pearls® 1400, Black Pearls® 1300, Black Pearls® 1000, Black Pearls® L, Monarch® 1000, Mogul® L, and Regal® 400, available commercially from Cabot Corporation.

In one embodiment, the modified pigment has attached at least one organic group where an “attached” organic group can be distinguished from an adsorbed group in that a soxhlet extraction for several hours (e.g., at least 4, 6, 8, 12, or 24 hours) will not remove the attached group from the pigment. In another embodiment, the organic group is attached to the pigment if the organic group cannot be removed after repeated washing with a solvent or solvent mixture that can dissolve the starting organic treating material but cannot disperse the treated pigment. In yet another embodiment, “attached” refers to a bond such as a covalent bond, e.g., a pigment bonded or covalently bonded to a nucleophile or organic group.

In one embodiment, the at least one organic group may be an aliphatic group, a cyclic organic group, or an organic compound having an aliphatic portion and a cyclic portion, e.g., arylene, heteroarylene, and alkylene. In one embodiment, the organic group is attached via a diazonium salt derived from a primary amine capable of forming, even transiently, a diazonium salt. Other methods of attachment are described below. The organic group may be substituted or unsubstituted, branched or unbranched. Aliphatic groups include, for example, groups derived from alkanes, alkenes, alcohols, ethers, aldehydes, ketones, carboxylic acids, and carbohydrates. Cyclic organic groups include, but are not limited to, alicyclic hydrocarbon groups (for example, cycloalkyls, cycloalkenyls), heterocyclic hydrocarbon groups (for example, pyrrolidinyl, pyrrolinyl, piperidinyl, morpholinyl, and the like), aryl groups (for example, phenyl, naphthyl, anthracenyl), and heteroaryl groups (imidazolyl, pyrazolyl, pyridinyl, thienyl, thiazolyl, furyl, indolyl, and triazolyl, such as 1,2,4-triazolyl and 1,2,3-triazolyl).

The arylene, heteroarylene, and alkylene can be unsubstituted or substituted. Exemplary arylenes include phenylene, naphthylene, and biphenylene, and exemplary heteroarylenes include phenylene, naphthylene, and biphenylene having a ring carbon substituted with one or more oxygen or nitrogen atoms. In one embodiment, the arylene is a C₅-C₂₀ arylene. Heteroarylenes can be an arylene as defined herein which one or more ring carbon atoms is replaced with a heteroatom, e.g., N, O, and S. The heteroatom can be bonded to other groups in addition to being a ring atom. Alkylenes may be branched or unbranched. The alkylene may be a C₁-C₁₂ alkylene such as methylene, ethylene, propylene, or butylene.

In one embodiment, the at least one attached organic group comprises at least one ionic group, ionizable group, or mixtures of an ionic group and an ionizable group. An ionic group can be either anionic or cationic and can be associated with a counterion of the opposite charge including inorganic or organic counterions, such as Na⁺, K⁺, Li⁺, NH₄⁺, NR′₄⁺, acetate, NO₃⁻, SO₄²⁻, R′SO₃, R′OSO₃⁻, OH⁻, or Cl⁻, where R′ represents hydrogen or an organic group, such as a substituted or unsubstituted aryl or alkyl group. An ionizable group is one that is capable of forming an ionic group in the medium of use. Anionic groups are negatively charged ionic groups that can be generated from groups having ionizable substituents that can form anions (anionizable groups), such as acidic substituents. Cationic groups are positively charged organic ionic groups that can be generated from ionizable substituents that can form cations (cationizable groups), such as protonated amines. Specific examples of anionic groups include —COO⁻, —SO₃⁻, —OSO₃⁻, —HPO₃⁻; —OPO₃²⁻, or —PO₃²⁻, and specific examples of an anionizable group can include —COOH, —SO₃H, —PO₃H₂, —R′SH, or —R′OH, where R′ represents hydrogen or an organic group, such as a substituted or unsubstituted aryl or alkyl group. Also, specific examples of cationic or cationizable groups include alkyl or aryl amines, which can be protonated in acidic media to form ammonium groups —NR′₂H⁺, where R′ represent an organic group, such as a substituted or unsubstituted aryl or alkyl groups. Organic ionic groups include those described in U.S. Pat. No. 5,698,016, the disclosure of which is incorporated herein by reference.

For example, the attached group may be an organic group such as a benzene carboxylic acid group (—C₆H₄—COOH) group), a benzene dicarboxylic acid group, a benzene tricarboxylic acid group, a benzene sulfonic acid group (a —C₆H₄—SO₃H group), or salts thereof. In one embodiment, surface modification to introduce ionic or ionizable groups onto a pigment surface, such as chlorination and sulfonylation, may also be used.

In one embodiment, the pigment (carbon black or colored pigment) is modified with at least one organic group via a diazonium treatment as detailed, for instance, in the following patents: U.S. Pat. Nos. 5,554,739; 5,630,868; 5,672,198; 5,707,432; 5,851,280; 5,885,335; 5,895,522; 5,900,029; 5,922,118; 6,042,643; 6,506,245, 6,534,569; 6,641,653, 7,223,302, 6,398,858 and 6,494,943 (high shear conditions) 6,372,820; 6,368,239; 6,350,519; 6,337,358; 6,103,380; 7,173,078; 7,056,962; 6,942,724; 6,929,889; 6,911,073; 6,478,863; 6,472,471; WO 2011/143533; and 8,858,695, the disclosures of which are incorporated herein by reference. In one embodiment, the attachment is provided via a diazonium reaction where the at least one organic group has a diazonium salt substituent. In another embodiment, the direct attachment can be formed by using the diazonium and stable free radical methods described, for instance, in U.S. Pat. Nos. 6,068,688; 6,337,358; 6,368,239; 6,551,393; 6,852,158, the disclosures of which are incorporated herein by reference, which makes use of reacting at least one radical with at least one particle, wherein a radical is generated from the interaction of at least one transition metal compound with at least one organo-halide compound in the presence of one or more particles capable of radical capture, and the like. In yet another embodiment, the pigment (carbon black or colored pigment) can be modified (e.g., to attach organic groups) by using the methods of U.S. Pat. Nos. 5,837,045, 6,660,075 and WO 2009/048564 (reaction with organic compounds containing a C—C double bond or triple bond activated by at least one substituent) or U.S. Pub. No. 2004/0171725, 6,664,312, 6,831,194 (reaction with anhydride component), 6,936,097, U.S. Pub. Nos. 2001/0036994, 2003/0101901 (reaction with organic groups having —N═N—N— group), Canadian Patent No. 2,351,162, European Patent No. 1394221, and PCT Publication Nos. WO 01/51566 (reaction between at least one electrophile and at least one nucleophile), WO 04/63289, WO 2010/141071 (reaction with H2N-A-Y where A is a heteroatom), and WO 99/23174, the disclosures of which are incorporated herein by reference.

In one embodiment, the at least one organic group attached to the pigment is capable of binding calcium (e.g., having defined calcium index values), including those organic groups described in PCT Pub. No. WO 2007/053564, the disclosure of which is incorporated herein by reference, the groups capable of binding calcium as described herein. For example, the organic group comprises at least one geminal bisphosphonic acid group, partial esters thereof, or salts thereof, e.g., a group having the formula-CQ(PO₃H₂)₂, partial esters thereof, or salts thereof, wherein Q is bonded to the geminal position and may be H, R, OR, SR, or NR₂ wherein R″, which can be the same or different, is defined as above, or can be H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. In addition, U.S. Pat. Nos. 5,672,198, 5,922,118, 6,042,643, and 6,641,656 disclose modified pigments having various attached groups, including phosphonic acid groups, the disclosures of which are incorporated herein by reference.

As an option, the liquid vehicle comprises water, e.g., the liquid vehicle is an aqueous solution, e.g., at least 40% or at least 50% water or at least 90% water or is water).

Another aspect is a composition comprising:
at least one pigment;
a liquid vehicle;
at least one polymer encapsulating the at least one pigment, the at least one polymer comprising first monomers selected from ethylenically unsaturated hydrophobic monomers, and second monomers selected from maleic anhydride, maleic acid, acrylic acid, methacrylic acid, benzylacrylic acid, benzylmethacrylic acid, and salts, esters, imides, and amides thereof, wherein the at least one polymer is crosslinked through at least 10% of carboxylate groups of the second monomer; and
at least one organic biological buffering agent having a pKa ranging from 6 to 8, wherein the at least one organic biological buffering agent is present in an amount ranging from 10 ppb to 1% by weight relative to the total weight of the composition.

As an option, the at least one biological buffering agent is present in an amount ranging from 10 ppb to 500 ppm, e.g., from 10 ppb to 250 ppm, from 10 ppb to 100 ppm, from 10 ppb to 75 ppm, from 10 ppb to 50 ppm, from 10 ppb to 25 ppm, from 10 ppb to 20 ppm, or from 10 ppb to 10 ppm.

As an option, the polymer encapsulating the at least one pigment is crosslinked through the second monomers as disclosed herein.

As an option, the composition is a pigment dispersion, e.g., comprising the polymer-encapsulated pigment in an aqueous liquid vehicle (e.g., water). As an option, the polymer-encapsulated pigment is present in the dispersion in an amount ranging from 0.1% to 25% by weight, e.g., from 0.1% to 20% by weight, from 0.2% to 25% by weight, from 0.2% to 20% by weight, from 0.5% to 25% by weight, or from 0.5% to 20% by weight relative to the total weight of the dispersion. As an option, the at least one biological buffering agent is present in an amount ranging from 10 ppb to 500 ppm, e.g., from 10 ppb to 250 ppm, from 10 ppb to 100 ppm, from 10 ppb to 75 ppm, from 10 ppb to 50 ppm.

As an option, the composition is an inkjet ink composition. As an option, the at least one biological buffering agent is present in an amount ranging from from 10 ppb to 25 ppm, from 10 ppb to 20 ppm, or from 10 ppb to 10 ppm.

As an option, an ink composition (e.g., an inkjet ink composition) comprises at least one surfactant, e.g., when the pigment is not self-dispersible. The at least one surfactant can enhance the colloidal stability of the composition or change the interaction of the ink with either the printing substrate, such as printing paper, or with the ink printhead. Various anionic, cationic and nonionic dispersing agents can be used in conjunction with the ink composition of the present invention, and these may be used neat or as a water solution. In one embodiment, the surfactant is present in an amount ranging from 0.05% to 5%, e.g., an amount ranging from 0.1% to 5%, or from 0.5% to 2%, by weight relative to the total weight of the inkjet ink composition.

As an option, the inkjet ink composition has a viscosity ranging from 1-25 cP.

As an option, the ink composition comprises at least one polymeric binder. Polymeric binders can be used in conjunction with the inkjet ink composition disclosed herein to adjust the viscosity of the composition and/or provide other desirable properties, such as durability (e.g., at least one durability polymer). As an option, the inkjet ink composition comprises at least one viscosity modifier.

As an option, the dispersion can be formulated to provide an amount of pigment such that the final amount in the inkjet ink composition is effective to provide the desired image quality (for example, optical density) without detrimentally affecting the performance of the inkjet ink. In one embodiment, the colorant (e.g., a pigment) is present in the dispersion in an amount ranging from 1% to 15% by weight, e.g., from 1% to 10% by weight, relative to the total weight of the composition, e.g., an amount ranging from 2% to 10% by weight, from 3% to 10% by weight, from 2% to 7% by weight, or from 3% to 7% by weight, relative to the total weight of the composition.

The inkjet ink compositions can further comprise one or more suitable additives to impart a number of desired properties while maintaining the stability of the compositions. Other additives are well known in the art and include humectants, biocides and fungicides, pH control agents, drying accelerators, penetrants, and the like. The amount of a particular additive will vary depending on a variety of factors but are generally present in an amount ranging between 0.01% and 40% based on the weight of the inkjet ink composition. As an option, the at least one additive is present in an amount ranging from 0.05% to 5%, e.g., an amount ranging from 0.1% to 5%, or an amount ranging from 0.5% to 2%, by weight relative to the total weight of the inkjet ink composition. These and other inkjet ink additives are disclosed in U.S. Pat. No. 10,233,342, the disclosure of which is incorporated by reference herein.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

### EXAMPLES

### Example 1

Polymer-pigment predispersions were prepared by mixing a polymer and pigment in deionized water. Two polymer types were used: styrene maleic anhydride or “SMA” (Xiran® 3000HNa SMA, 25.7% solids, Polyscope); and styrene acrylic resins or “St-AA” (Joncryl® 683 acrylic resin, BASF). The SMA was used as purchased. For styrene acrylic resins, prior to forming the predispersion, 300 g of the resin was mixed with NaOH aqueous solution (84 g, 40% solids, Sigma-Aldrich) in 1200 g of deionized water in a 2 L glass flask under overhead stirring at 70 °C for 2 hours. The St-AA solution was then cooled to ambient temperature with a pH=8.9.

The pigments used were: Pigment Red 122 (Clariant AG), Pigment Blue 15:3 B2G (Clariant AG), Pigment Yellow 74 (Sun Chemical Corporation), and Black Pearls® 900 carbon black (Cabot Corporation).

To form the polymer-pigment predispersion:
SMA: the SMA (100 g) was mixed with the pigment (57 g) in 360 g deionized water with a Silverson L4RT High Speed Mixer at 3000 rpm for 30 min;
St-AA: the styrene acrylic solution prepared above (135 g) was mixed with the pigment (60 g) in the same manner and under the same conditions.

The polymer-pigment predispersions were subjected to a crosslinking reaction in the presence of a crosslinking agent and a buffer. The control samples were prepared by (i) crosslinking without a buffer, (ii) crosslinking in the presence of boric acid (BA), and (iii) crosslinking in the presence of tetraethanolamine (TEA). All buffers evaluated are listed in Table 1, along with the respective pKa and amount added to for the crosslinking reaction.

TABLE 1

| | | Amount |
|---|---|---|
| Buffer | pKa | added (g) |
| Boric Acid (BA) | 9.15 | 0.14 |
| Triethanolamine (TEA) | 7.76 | 0.339 |
| 3-(N-morpholino)propanesulfonic acid (MOPS) | 7.15 | 0.475 |
| 1,4-Piperazinediethanesulfonic acid (PIPES) | 6.82 | 0.343 |
| 4-(2-Hydroxyethyl)-1-piperazineethanesulfonic acid (HEPES) | 7.55 | 0.541 |
| 2-(N-morpholino)ethanesulfonic acid monohydrate (MES) | 6.15 | 0.484 |

For the crosslinking reaction, the predispersion (15 g) was transferred to a 20 mL glass vial and heated to 65 °C. The buffer and crosslinking agent, trimethylolpropane triglycidyl ether (0.153 g, Sigma-Aldrich) were then added to the vial. The molar ratio of acid groups from the buffer to epoxide functional groups from the crosslinker was maintained at 1.5. The mixture was shaken at 65 °C for 4 hours. After completion of the crosslinking reaction, the dispersion was cooled to ambient temperature.

The crosslinked products, or polymer-encapsulated dispersions, were evaluated based on molecular weight measurements and boron content measurements.

Molecular weight measurements. Samples containing polymer-encapsulated pigment dispersions were prepared for gel permeation chromatography (GPC) analysis by a centrifugation (“spin down”) step to remove insoluble and high molecular weight particulate material prior to analysis. The dispersion (10 g) was centrifuged at 70,000 revolutions per minute (rpm) for a period of 120 minutes at ambient temperature. Following centrifugation, the clarified supernatant was separated from the sediment and used for subsequent GPC analysis. Molecular weights of polymer in supernatant (Mn-Number average molecular weight, Mw-Weight average molecular weight, Mp-Peak average molecular weight) were measured relative to Polystyrene calibration standards manufactured by Agilent. Polymer samples and calibration standards were dissolved in the mobile phase (0.1% trifluoroacetic acid, 99.9% tetrahydrofuran stabilized with BHT) and after ~1 hour were injected into the GPC system.

Boron content measurement. Boron content in inkjet dispersions was measured using Inductively Coupled Plasma-Optical Emission Spectroscopy (ICP OES). Samples are initially prepared by weighing approximately 1 g of material and diluting to a total mass of 10 g with reagent grade water (RGW). Calibration is performed using NIST traceable multi element standards prepared in 0.1% trace metal grade nitric acid with 1 ppm strontium as an internal standard, consisting of a blank, four calibration levels (0.1-5.0 ppm), and a second source verification standard that must meet ±5% recovery criteria. Analysis is conducted using an ICP OES equipped with a double pass spray chamber and crossflow nebulizer, and calibration is verified by bracketing the run with the second-source verification standard. Samples are re diluted in RGW and reanalyzed if concentrations exceed the calibration range. Results are reported as ppm of Boron per gram of inkjet dispersion.

Table 2 lists the results of the evaluations for a number of polymer-encapsulated pigment dispersions.

TABLE 2

| Example No. | Polymer | Buffer | Pigment | Mw | B content (ppm) |
|---|---|---|---|---|---|
| Comp 1 | SMA | none | CB | 1.3 × 10⁴ | 5 |
| Comp 2 | SMA | BA | CB | 1.7 × 10⁴ | 1365 |
| Comp 3 | SMA | TEA | CB | 1.8 × 10⁴ | 13 |
| Ex. 1 | SMA | MOPS | CB | 2.9 × 10⁴ | 3 |
| Ex. 2 | SMA | PIPES | CB | 3.4 × 10⁴ | 2 |
| Ex. 3 | SMA | HEPES | CB | 7.5 × 10⁴ | 2 |
| Ex. 4 | SMA | MES | CB | 6.9 × 10⁴ | 2 |
| Comp 4 | SMA | N/A | PR 122 | 1.6 × 10⁴ | 9 |
| Comp 5 | SMA | BA | PR 122 | 2.6 × 10⁴ | 1453 |
| Comp 6 | SMA | TEA | PR 122 | 2.3 × 10⁴ | 24 |
| Ex. 5 | SMA | MOPS | PR 122 | 6.3 × 10⁴ | 2 |
| Ex. 6 | SMA | PIPES | PR 122 | 5.6 × 10⁴ | 3 |
| Ex. 7 | SMA | HEPES | PR 122 | 1.1 × 10⁵ | 3 |
| Ex. 8 | SMA | MES | PR 122 | 5.3 × 10⁴ | 2 |
| Comp 7 | SMA | none | PY 74 | 1.7 × 10⁴ | 13 |
| Comp 8 | SMA | BA | PY 74 | 3.6 × 10⁴ | 1731 |
| Comp 9 | SMA | TEA | PY 74 | 2.0 × 10⁴ | 42 |
| Ex. 9 | SMA | MOPS | PY 74 | 1.5 × 10⁵ | 3 |
| Ex. 10 | SMA | PIPES | PY 74 | 6.5 × 10⁴ | 6 |
| Ex. 11 | SMA | HEPES | PY 74 | 9.1 × 10⁴ | 4 |
| Ex. 12 | SMA | MES | PY 74 | 1.2 × 10⁵ | 3 |
| Comp 10 | SMA | none | PB 15:3 B2G | 2.1 × 10⁴ | 20 |
| Comp 11 | SMA | BA | PB 15:3 B2G | 3.3 × 10⁴ | 1675 |
| Comp 12 | SMA | TEA | PB 15:3 B2G | 1.3 × 10⁴ | 47 |
| Ex. 13 | SMA | MOPS | PB 15:3 B2G | 1.1 × 10⁵ | 9 |
| Ex. 14 | SMA | PIPES | PB 15:3 B2G | 1.5 × 10⁵ | 12 |
| Ex. 15 | SMA | HEPES | PB 15:3 B2G | 6.1 × 10⁴ | 11 |
| Ex. 16 | SMA | MES | PB 15:3 B2G | 4.7 × 10⁵ | 13 |
| Comp 13 | St-AA | none | PR 122 | 1.6 × 10⁴ | 8 |
| Comp 14 | St-AA | BA | PR 122 | 2.5 × 10⁴ | 1581 |
| Comp 15 | St-AA | TEA | PR 122 | 1.3 × 10⁴ | 22 |
| Ex. 17 | St-AA | MOPS | PR 122 | >5.0 × 10⁵ | 3 |
| Ex. 18 | St-AA | PIPES | PR 122 | >5.0 × 10⁵ | 42 |
| Ex. 19 | St-AA | HEPES | PR 122 | >5.0 × 10⁵ | 3 |
| Ex. 20 | St-AA | MES | PR 122 | >5.0 × 10⁵ | 14 |
| Comp 16 | St-AA | none | CB | 1.3 × 10⁴ | 6 |
| Comp 17 | St-AA | BA | CB | 2.0 × 10⁴ | 1399 |
| Comp 18 | St-AA | TEA | CB | 1.4 × 10⁴ | 21 |
| Ex. 21 | St-AA | MOPS | CB | 6.1 × 10⁴ | 15 |
| Ex. 22 | St-AA | PIPES | CB | >5.0 × 10⁵ | 16 |
| Ex. 23 | St-AA | HEPES | CB | >5.0 × 10⁵ | 2 |
| Ex. 24 | St-AA | MES | CB | >5.0 × 10⁵ | 12 |

From the data of Table 2, the Comparative Examples all yielded polymer-encapsulated dispersions in which the molecular weights of the polymer were noticeably lower than the dispersions formed by crosslinking in the presence of organic biological buffering agents. Without wishing to be bound by any theory, higher molecular weight values can be associated with polymer chain lengths that are more effective in encapsulating the pigment, leading to more stable dispersions. The use of organic biological buffering agents also provide a less toxic and more sustainable product as indicated by the low boron content.

1. A method of making a polymer-encapsulated pigment, comprising:
combining a polymer-pigment predispersion with at least one organic biological buffering agent to form a mixture, wherein the buffering agent has a pKa ranging from 6 to 8 and is free of NH₂ and OH groups, and wherein the polymer of the polymer-pigment predispersion comprises first monomers selected from ethylenically unsaturated hydrophobic monomers, and second monomers selected from maleic anhydride, maleic acid, acrylic acid, methacrylic acid, benzylacrylic acid, benzylmethacrylic acid, and salts, esters, imides, and amides thereof, and
combining the polymer-pigment predispersion and buffering agent mixture with a crosslinking agent to form the polymer-encapsulated pigment comprising a crosslinked polymer that is crosslinked through carboxylate groups of the second monomers.

2. The method of claim 1, wherein the at least one buffering agent has a pKa ranging from 6 to 7.5.

3. The method of claim 1, wherein the at least one buffering agent is selected from Good's buffers.

4. The method of claim 1, wherein the at least one buffering agent comprises a piperazinyl or morpholinyl residue.

5. The method of claim 1, wherein the at least one buffering agent is also free of CO₂H groups.

6. The method of claim 1, wherein the at least one buffering agent is selected from 3-(N-morpholino) propanesulfonic acid (MOPS), 2-(N-morpholino) ethanesulfonic acid (MES), 1,4-Piperazinediethanesulfonic acid (PIPES), and salts thereof.

7.-9. (canceled)

10. The method of claim 1, wherein the crosslinking agent is an epoxy-containing compound.

11. (canceled)

12. (canceled)

13. The method of claim 1, wherein the crosslinked polymer has an acid number ranging from 100 to 300 mg KOH/g.

14. (canceled)

15. The method of claim 1, wherein the crosslinked polymer has a weight average molecular weight (M_{w}) of at least 1000.

16.-18. (canceled)

19. The method of claim 1, wherein the second monomers are selected from maleic anhydride, maleic acid, and salts, esters, imides, and amides thereof.

20. The method of claim 1, wherein the second monomers are selected from acrylic acid, methacrylic acid, and salts, esters, imides, and amides thereof.

21. (canceled)

22. (canceled)

23. The method of claim 1, wherein the step of combining the polymer-pigment predispersion and buffering agent mixture with a crosslinking agent occurs in a liquid vehicle comprising water.

24. The method of claim 23, wherein the liquid vehicle is aqueous.

25. A method of making a polymer-encapsulated pigment, comprising:
combining a polymer-pigment predispersion with at least one organic biological buffering agent to form a mixture, wherein the buffering agent has a pKa ranging from 6 to 8 and comprises a piperazinyl or morpholinyl residue, and wherein the polymer of the polymer-pigment predispersion comprises first monomers selected from ethylenically unsaturated hydrophobic monomers, and second monomers selected from maleic anhydride, maleic acid, acrylic acid, methacrylic acid, benzylacrylic acid, benzylmethacrylic acid, and salts, esters, imides, and amides thereof, and
combining the polymer-pigment predispersion and buffering agent mixture with a crosslinking agent to form the polymer-encapsulated pigment comprising a crosslinked polymer that is crosslinked through carboxylate groups of the second monomers.

26. The method of claim 25, wherein the at least one buffering agent has a pKa ranging from 6 to 7.5.

27. The method of claim 25, wherein the at least one buffering agent is selected from Good's buffers.

28. (canceled)

29. The method of claim 25, wherein the at least one buffering agent is selected from 3-(N-morpholino) propanesulfonic acid (MOPS), 2-(N-morpholino) ethanesulfonic acid (MES), 1,4-Piperazinediethanesulfonic acid (PIPES), 4-(2-Hydroxyethyl)-1-piperazineethanesulfonic acid (HEPES), and salts thereof.

30.-37. (canceled)

38. A composition comprising:
at least one pigment;
a liquid vehicle;
at least one polymer encapsulating the at least one pigment, the at least one polymer comprising first monomers selected from ethylenically unsaturated hydrophobic monomers, and second monomers selected from maleic anhydride, maleic acid, acrylic acid, methacrylic acid, benzylacrylic acid, benzylmethacrylic acid, and salts, esters, imides, and amides thereof, wherein the at least one polymer is crosslinked through at least 10% of carboxylate groups of the second monomer; and
at least one organic biological buffering agent having a pKa ranging from 6 to 8, wherein the at least one organic biological buffering agent is present in an amount ranging from 10 ppb to 1% by weight relative to the total weight of the composition.

39. The composition of claim 38, wherein the at least one organic biological buffering agent has a pKa ranging from 6 to 7.5.

40. The composition of claim 38, wherein the at least one organic biological buffering agent is free of at least one of NH₂, OH, and CO₂H groups.

41.-43. (canceled)

44. The composition of claim 38, wherein the at least one buffering agent comprises a piperazinyl or morpholinyl residue.

45. The composition of claim 38, wherein the at least one buffering agent is selected from 3-(N-morpholino) propanesulfonic acid (MOPS), 2-(N-morpholino) ethanesulfonic acid (MES), 1,4-Piperazinediethanesulfonic acid (PIPES), 4-(2-Hydroxyethyl)-1-piperazineethanesulfonic acid (HEPES), and salts thereof.

46.-62. (canceled)
